(19) United States
(12) Patent Application Publication
(10) Pub. No.: US 2026/0074532 A1
(43) Pub. Date: Mar. 12, 2026

(54) PROGRAMMABLE BATTERY PACK

(71) Applicant: Mushtaq Mhaws, Worcester, MA (US)

(72) Inventor: Mushtaq Mhaws, Worcester, MA (US)

(21) Appl. No.: 18/828,415

(22) Filed: Sep. 9, 2024

(51) Int. Cl. H02J 7/00; H01M 10/42; H01M 10/44; H01M 10/46; H01M 10/48

(52) U.S. Cl. CPC H02J 7/54; H01M 10/4257; H01M 10/441; H01M 10/443; H01M 10/46; H01M 10/482; H01M 10/486; H02J 7/94; H02J 7/96; H02J 7/977; H01M 2010/4271

(57) ABSTRACT

A programmable battery pack including a switch arrangement module having at least one rechargeable battery with and at least one single pole single throw (SPST) switch, a system power supply having at least one linear regulator and at least one single pole single throw (SPST) switch, at least one controller module having a micro-controller executing a pre-programmed firmware, and an external power supply.

### TECHNICAL FIELD

The present invention relates to battery packs.

### BACKGROUND

Battery packs have a wide range of applications. With that said, most commercially used battery packs have a narrow range of optimal charging voltages and specific current restrictions. Charging a battery outside of the optimal charging voltage can lessen the battery's life and charging a battery with the incorrect current strength can lead to battery damage.

Additionally, battery packs contain multiple battery cells with varying capacities, which can lead to the cells having different levels of charge over time. Therefore, battery packs are often coupled with balancing hardware to balance the charges and maximize the capacity of the individual battery cells.

Battery packs with multiple different voltage outputs often use Buck-Boost DC/DC convertors that generate a varying electromagnetic field that interferes with other devices.

### SUMMARY

The object of the invention is to provide programmable interconnections between battery cells in a programmable battery pack to allow charging with a wide range of voltages, eliminate a need for dedicated balancing hardware and multiple different voltage outputs, and which does not generate electromagnetic interference while discharging.

The programmable battery pack in the present disclosure includes an external power supply, a system power supply, an at least one controller module, a switch arrangement module, and an at least one switch.

According to one aspect of the invention, the external power supply is connected to a charging terminal. The charging terminal connects the negative end of the external power supply to the common ground (GND), which is connected to all modules of the programmable battery pack.

In the preferred embodiment, the external power supply feeds a liner regulator and a DC/DC convertor. The DC/DC convertor is the front end of the internal charger module. The DC/DC convertor has three inputs: an input from the charging terminal and two inputs set by the controller module.

The DC/DC converter then feeds the rest of the internal charger module. In order to enable the DC/DC convertor, the controller module increases one of the inputs. Similarly, in order to disable the DC/DC convertor, the controller module decreases one of the inputs.

In the preferred embodiment, the linear regulator feeds the at least one controller module, and the internal charger module. The at least one switch enables or disables the linear regulator by controlling one input of the linear regulator. When the at least one switch is in an open position, one of the two inputs of the linear regulator changes in such a way that the linear regulator is activated. When the at least one switch is in a closed position, one of the two inputs of the linear regulator changes in such a way that the linear regulator is deactivated.

In the preferred embodiment, the external power supply is a linear power supply or a switching mode power supply.

In other embodiments, the external power supply is a Buck-Boost DC/DC convertor.

In still other embodiments, the external power supply is an automobile battery or a solar cell panel.

In the preferred embodiment, the at least one controller module comprises a voltage sensor, a temperature sensor, a micro-controller, a high side control bus, a low side control bus, a programming and communication port, and a mixed signal port.

The at least one controller module is only active when the linear regulator of the system power supply is active.

The at least one controller module is programmed with algorithms to manage and control the programmable battery pack. The at least one controller module uses the pre-programmed algorithms in conjunction with data collected by other modules to arrange the battery cells in the most efficient way.

In the preferred embodiment, the voltage sensor of the at least one controller module comprises a resistors network acting as a voltage measurement circuit. The voltage sensor conditions the potential difference between the positive end of the external power supply and the negative end of the external power supply (GND).

In the preferred embodiment, the voltage sensor of the at least one controller module comprises a resistors network acting as a voltage measurement circuit. The voltage sensor conditions the potential difference between the positive output end of the DC/DC convertor and the negative end of the DC/DC convertor (GND).

In the preferred embodiment, the temperature sensor of the at least one controller module comprises one or more Negative Temperature Coefficient (NTC) resistors.

In the preferred embodiment, the low side control bus and the high side control bus configures the switch arrangement module. This configuration occurs by the individual or simultaneous setting of one or more signal paths in the control buses by a micro-controller comprised in the at least one controller module. The number of signal paths comprised by the control buses is equal to the number of battery cells present in the programmable battery pack.

In the preferred embodiment, the programming and communication port comprises at least one network coupler and at least one signal path. The at least one network coupler is connected to the micro-controller. The at least one network coupler acts as the reset pin of the micro-controller.

In the preferred embodiment, the mixed signal port feeds analog signals to the micro-controller, communicating charging current and temperature readings from at least one node. The mixed signal port also regulates the DC/DC convertor through connections to the micro-controller. If the signal voltage from the mixed signal port to the micro-controller is relatively high (e.g., 3.3 V), then the DC/DC convertor is active. If the signal voltage from the mixed signal port to the micro-controller is relatively low (e.g., 0 V), then the DC/DC convertor is inactive.

In the preferred embodiment, the internal charger module comprises a current sensor, a voltage sensor, and a temperature sensor. The three sensors send their respective data to the at least one controller module via coupling. The at least one controller module then compares the inputted data to a pre-programmed algorithm. If the data varies from the algorithm, the at least one controller module adjusts the switch arrangement module.

The current sensor uses a resistor and an amplifier.

In some embodiments, the voltage sensor measures the voltage at more than one node. In these embodiments, the voltage sensor has more than one output coupler.

In some embodiments, the internal charger module contains more than one temperature sensor. The amount of temperature sensors is equal to the number of points at which the temperature is measured. In these embodiments, each temperature sensor has its own output coupler.

In the preferred embodiment, the temperature sensors are Negative Temperature Coefficient (NTC) resistors.

In the preferred embodiment, the at least one switch is a single pole single throw (SPST) switch. When the at least one switch is in an open position and the external power supply is on, the programmable battery pack is in Charge Mode. When the at least one switch is in a closed position, the programmable battery pack is off.

In the preferred embodiment, at least one switch is a single pole single throw (SPST) switch. When the at least one switch is in a closed position and the external power supply is off, the programmable battery pack is in On-Demand Self Balance Mode. In On-Demand Self Balance Mode, stored energy is re-distributed equally among the battery cells allowing unused or partially drained cells to share their charge with others. When the at least one switch is in an open position and the external power supply is off, the programmable battery pack is in Discharge Mode.

In some embodiments, the programmable battery pack has a secondary power supply. The secondary power supply comprises a linear regulator, a DC/DC convertor, and an SPST switch. When the SPST switch of the secondary power supply is in a closed position, the linear regulator is disabled and has no output. When the SPST switch of the secondary power supply is in an open position, the linear regulator is active. When the external power supply is on, the linear regulator is disabled.

### BRIEF DESCRIPTION OF THE DRAWINGS

The system may be more completely understood in consideration of the following detailed description of various embodiments of the system in connection with the accompanying drawings, in which:

FIG. 1 is a system diagram of a programmable battery pack.

FIG. 2 is a system diagram of a system power supply thereof.

FIG. 3 is a schematic diagram of a switch arrangement module thereof.

FIG. 4 is a schematic diagram of system output module thereof.

FIG. 5 is a system diagram of a charge controller module thereof.

FIG. 6 is a system diagram of a discharge controller module thereof.

FIG. 7 is a system diagram of external loads thereof.

FIG. 8 is a system diagram of external chargers thereof.

FIG. 9A is a system diagram of a system power supply of the programmable battery pack in active Charge Mode.

FIG. 9B is a system diagram of a system power supply of the programmable battery pack in inactive Charge Mode.

FIG. 10 is a schematic diagram of the system output module of the programmable battery pack in Charge Mode.

FIG. 11 is a system diagram of a discharge controller module of the programmable battery pack in Charge Mode.

FIG. 12 is a system diagram of a system power supply of the programmable battery pack in On-Demand Self Balance Mode.

FIG. 13 is a schematic diagram of a switch arrangement module to measure the voltage of a first cell of the programmable battery pack.

FIG. 14 is a schematic diagram of a switch arrangement module to measure the voltage of a second cell of the programmable battery pack.

FIG. 15 is a schematic diagram of a switch arrangement module to measure the voltage of a third cell of the programmable battery pack.

FIG. 16 is a schematic diagram of a switch arrangement module to measure the voltage at a fourth cell of the programmable battery pack.

FIG. 17 is a schematic diagram of a switch arrangement module to charge a first cell of the programmable battery pack.

FIG. 18 is a schematic diagram of a switch arrangement module to charge a first cell and a second cell of the programmable battery pack in parallel.

FIG. 19 is a schematic diagram of a switch arrangement module to charge a first cell, a second cell, and a third cell of the programmable battery pack in parallel.

FIG. 20 is a schematic diagram of a switch arrangement module to charge a first cell, a second cell, a third cell, and a fourth cell of the programmable battery pack in parallel.

FIG. 21 is a schematic diagram of a switch arrangement module to charge a first cell and a second cell of the programmable battery pack in series.

FIG. 22 is a schematic diagram of a switch arrangement module to charge a first cell and a second cell of the programmable battery pack in parallel with a third cell and a fourth cell of a programmable battery pack.

FIG. 23 is a schematic diagram of a switch arrangement module to charge a second cell, a third cell, and fourth cell of the programmable battery pack in series.

FIG. 24 is a schematic diagram of a switch arrangement module to charge a first cell, a second cell, a third cell, and a fourth cell of the programmable battery pack in series.

FIG. 25 is a system diagram of a charge controller module of the programmable battery pack in Discharge Mode.

FIG. 26 is a system diagram of the system power supply of a programmable battery pack in Discharge Mode.

FIG. 27A is a schematic diagram of the switch arrangement module of a programmable battery pack in Discharge Mode.

FIG. 27B is a schematic diagram of a switch arrangement module of an external load of the programmable battery pack in Discharge Mode.

FIG. 27C is a schematic diagram of a switch arrangement module of an external load of the programmable battery pack in Discharge Mode.

FIG. 28A is a schematic diagram of a switch arrangement module of the programmable battery pack in Discharge Mode.

FIG. 28B is a schematic diagram of a switch arrangement module of an external charger of the programmable battery pack in Discharge Mode.

### DETAILED DESCRIPTION

A programmable battery pack according to the present disclosure may be arranged in such a way that an external power supply provides charge to a system power supply that is connected to at least one controller module and a switch arrangement module. The switch arrangement module is further connected to a system output module that connects battery cells within the switch arrangement module to at least one external load or charger. The at least one controller module is able to adjust the configuration of at least one switch within the switch arrangement module or the system output module to produce efficient charging or discharging.

The programmable battery pack is able to enter three different modes: Charge Mode, Discharge Mode, and On-Demand Self Balance Mode. Charge Mode allows the battery cells within the programmable battery pack to be charged. While in Charge Mode, the system output module is disabled and no electric current is provided to the at least one external load or sunk from at least one external charger. Discharge Mode allows electric current to be delivered to the at least one external load or from at least one external charger. On-Demand Self Balance Mode allows stored energy to be re-distributed equally among the battery cells allowing unused or less drained cells to share their charge with others. While in On-Demand Self Balance mode, the system output module is disabled and no electric current is sourced to the at least one external load or sunk from the at least one external charger.

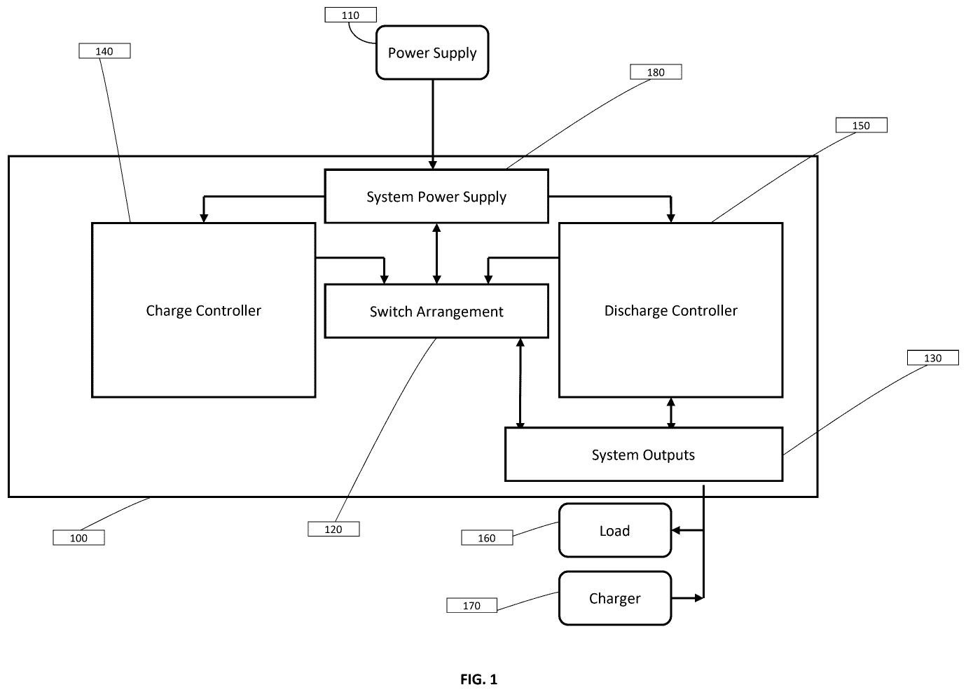

FIG. 1 shows a system diagram of a preferred embodiment of a programmable battery pack 100. In this embodiment, the system power supply 180 is connected to a charge controller module 140 and a discharge controller module 150. The charge controller module 140 controls the configuration of switches within a switch arrangement module 120 and the discharge controller module 150 controls the configuration of switches within both the switch arrangement module 120 and the system output module 130. The system output module 130 is further connected to an external load module 160 in order to supply them with electric current and an external charger module 170 to input electric current from when at least one switch within the system output module 130 is properly configured.

The external power supply 110, external load module 160, and external charger module 170 represent external devices connected to the programmable battery back 100 that are not necessarily present in other embodiments.

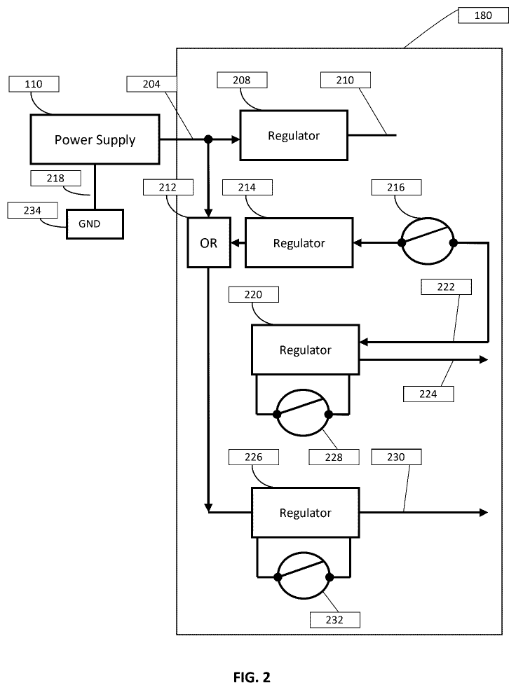

As shown in FIG. 2, in a preferred embodiment, the positive terminal of the external power supply 110 is connected via coupling 204 to the system power supply 180 and the negative terminal of the external power supply 110 is connected to a common ground (GND) 234 via a conductor 218. The external power supply 110 may be capable of charging at one or more voltages, with one or more current limitations.

In a preferred embodiment, the system power supply comprises at least one regulator connected to the external power supply, an ORing diode, and at least one single pole single throw (SPST) switch.

In this embodiment, as shown in FIG. 2, a first regulator 208 is connected to the external power supply 110. The ORing diode 212 further connects the positive terminal of the external power supply 110 and the output of a second regulator 214 to a fourth regulator 226. A first SPST switch 216 is connected to the second regulator 214 and a third regulator 220, which is also connected to a second SPST switch 228. The fourth regulator 226 is connected a third SPST switch 232.

In this embodiment, the input of the third regulator 220 serves to connect the system power supply 180 to the switch arrangement module 120 via a conductor 222. Specifically, the input of the third regulator 220 at the conductor 222 is connected to a conductor 380 at the positive terminal of a first cell 352 in the switch arrangement module 120. The measured voltage at the conductor 222 varies and is dependent on the voltage of the first cell 352. The third regulator 220 also connects the system power supply 180 to the discharge controller module 150. The fourth regulator 226 connects the system power supply 180 to the charge controller module 140 via a conductor 230.

In this embodiment, the first regulator 208 is a DC/DC convertor, the second regulator 214 is a boost regulator, and the third and fourth regulators 220, 226 are each linear regulators. The first regulator 208 may accept wide input voltages from the external power supply 110 at a coupling 204 and may also produce a wide range of output voltages at a conductor 210. For example, the measured voltage at the conductor 210 may vary from zero volts to 40 volts. Similarly, the fourth regulator 226 is a wide input voltage regulator.

In other embodiments, the first regulator 208 may be a linear regulator, like the third and fourth regulators 220, 226.

In a preferred embodiment, the first regulator 208 sets the voltage at the conductor 210 to a predefined value based on signals received from the first controller 502 within the charge controller module 140.

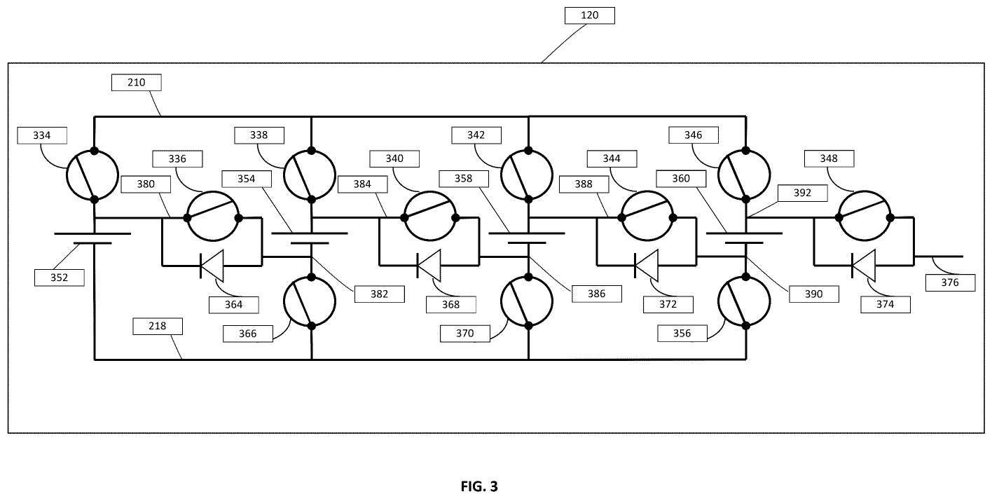

FIG. 3 shows a preferred embodiment of the switch arrangement module 120. In this embodiment, there are four cells 352, 354, 358, 360, each connected to their own diode 364, 368, 372, 374. The diodes keep the current flowing in only one direction. Specifically, they prevent current flow from conductor 380 to conductor 382, conductor 384 to conductor 386, conductor 388 to conductor 390, and conductor 392 to conductor 376.

In this embodiment, the switch arrangement module also comprises four SPST switches 336, 340, 344, 348 that each corresponds to a single cell and diode pair. When the SPST switch is in a closed position, its corresponding diode is shorted. The first SPST switch 336 controls the first diode 364, the second SPST switch 340 controls the second diode 368, the third SPST switch 344 controls the third diode 372, and the fourth SPST switch 348 controls the fourth diode 374.

In this embodiment, the diodes 364, 368, 372, 374 are each high current low drop diodes. In other embodiments, the diodes may be of a different kind. Additionally, the diodes may be built directly into the switches.

The switch arrangement module 120 has at least one additional switch to allow the at least one controller module to arrange the cells in different formations to maximize charging and discharging efficiency.

In the preferred embodiment, as shown in FIG. 3, there are seven switches 334, 338, 342, 346, 356, 366, 370 in addition to those corresponding directly to a diode. The seven switches 334, 338, 342, 346, 356, 366, 370 allow the charge controller module 140 to arrange the four cells 352, 354, 358, 360 in a variety of different configurations, including, but not limited to: all four cells 352, 354, 358, 360 in series, all four cells 352, 354, 358, 360 in parallel, and the first cell 352 and the second cell 354 in series, in parallel to the third cell 358 and the fourth cell 360 in series. Additionally, they allow the charge controller module 140 to deactivate individual cells, while leaving others active.

In this embodiment, the seven switches 334, 338, 342, 346, 356, 366, 370 are also SPST switches, and each of the SPST Switches 334, 336, 338, 340, 342, 344, 346, 348, 356, 366, 370 may be N-MOSFET (Negative Channel metal-oxide-semiconductor field-effect transistor) or P-MOSFET (Positive Channel metal-oxide-semiconductor field-effect transistor). The SPST switches 334, 336, 338, 340, 342, 344, 346, 348, 356, 366, 370 do not all have to be of the same kind and can be a combination of N-MOSFET and P-MOSFET. Additionally, the four cells 352, 354, 358, 360 are rechargeable battery cells.

In other embodiments, there may be a varying number of cells and a varying number of switches. Additionally, the switches may be single pole double throw (SPDT) switches.

In the preferred embodiment, the SPST switches 334, 336, 338, 340, 342, 344, 346, 348, 356, 366, 370, are configured to connect the four Cells 352, 354, 358, 360 to either the output at the conductor 210 of the first regulator 208 or the common ground (GND) 234.

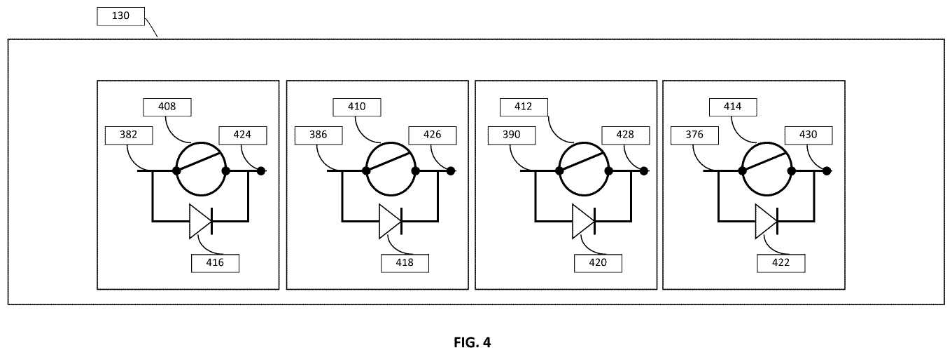

FIG. 4 shows a preferred embodiment of a system output module. The system output module serves as a connection between cells within the switch arrangement module 120 and the external loads and/or external chargers. The programmable battery pack 100 should have at least one system output within the system output module 130, but no more than the number of cells present in the programmable battery pack 100. For instance, a programmable battery pack 100 with four cells should have at least one system output, but no more than four.

In the preferred embodiment, the system output module 130 comprises four system outputs: the first system output 424, the second system output 426, the third system output 428, and the fourth system output 430, each connected to its own switch and diode pair.

In this embodiment, the switches 408, 410, 412, 414 are SPST switches and may be N-MOSFET (Negative Channel metal-oxide-semiconductor field-effect transistor) or P-MOSFET (Positive Channel metal-oxide-semiconductor field-effect transistor). The SPST switches 408, 410, 412, 414 do not all have to be of the same kind and can be a combination of N-MOSFET and P-MOSFET.

Additionally, the diodes 416, 418, 420, 422 are each high current low drop diodes. Each of the diodes 416, 418, 420, 422 allows current to flow in only one direction. Specifically, from conductor 382 to the first system output 424, from conductor 386 to the second system output 426, from conductor 390 to the third system output 428, and from conductor 376 to the fourth system output 430 when each of the SPST switches 408, 410, 412, 414 is in an open position.

The programmable battery pack 100 has at least one controller module to configure at least one switch in response to data collected from at least one sensor. In the preferred embodiment, the programmable battery pack 100 has two controller modules: a charge controller module 140 and a discharge controller module 150.

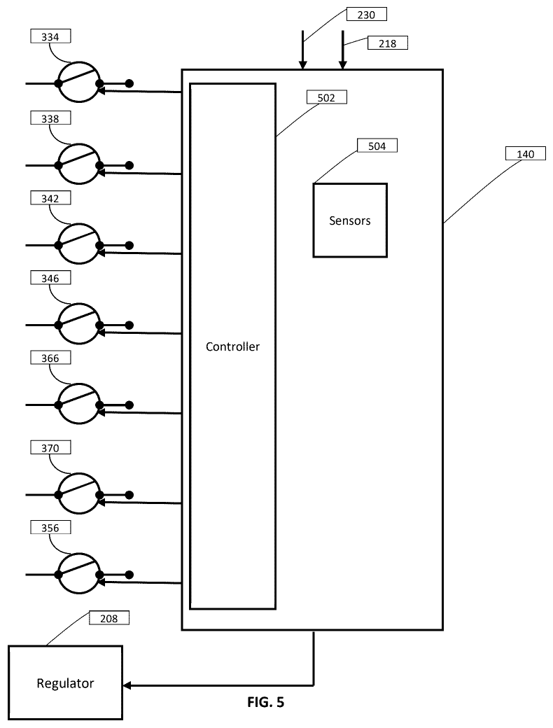

FIG. 5 shows a preferred embodiment of the charge controller module 140. The charge controller module 140 is responsible for configuring the seven switches 334, 338, 342, 346, 356, 366, 370 in the switch arrangement module 120 that are not paired with a diode. In this embodiment, the first controller 502 is a single chip micro-controller (MCU). In other embodiments, the first controller 502 may be an ASIC, a FPGA, a CPLD, or a CPU.

The first controller 502 executes a pre-programmed firmware that resides internally on the single-chip micro-controller. In embodiments using an ASIC, a FPGA, or a CPLD as the first controller 502, the firmware may reside internally or on an external memory chip. In embodiments using a CPU as the first controller 502, the firmware resides on an external memory chip.

The first controller 502 compares the pre-programmed firmware to data collected by sensors 504 within the module to determine the optimal switch configurations. In this embodiment, the sensors 504 comprise a temperature sensor, a voltage sensor, and a charging current sensor. The first controller 502 may place any of the seven switches 334, 338, 342, 346, 356, 366, 370 in an open or closed position simultaneously or individually.

The switch configuration affects the way in which the cells within the switch arrangement module 120 are connected. In the preferred embodiment, the first controller 502 is able to alter the switch configurations so that the cells are arranged in any of the ways listed in Table 1.

When charging any cell alone or any parallel combination, the first controller 502 increases the output voltage of the first regulator 208 at the conductor 210 from zero volts to the maximum allowed charging voltage of the cell. When charging any series combination, the first controller 502 increases the output voltage of the first regulator 208 at the conductor 210 from zero volts to the maximum charging voltage multiplied by the count of the cells that are connected in series. For example, if the maximum charging voltage is 3.6 volts and there are two cells in series, then the output voltage of the first regulator 208 is 7.2 volts. If all cells in this embodiment are connected in series (Cell1+Cell2+Cell3+Cell4) then the output voltage of the first regulator 208 is 14.4 volts.

TABLE 1

| | | | |
|---|---|---|---|
| Cell1 alone | Cell2 alone | Cell3 alone | Cell4 alone |

| | | |
|---|---|---|
| Cell1 // Cell2 | Cell2 // Cell3 | Cell3 // Cell 4 |
| Cell1 // Cell 3 | Cell2 // Cell4 | |
| Cell1 // Cell4 | Cell2 // Cell3 // Cell4 | |
| Cell1 // Cell 2 //Cell3 | | |
| Cell1 // Cell2 // Cell4 | | |
| Cell1 // Cell3 // Cell4 | | |
| Cell1 // Cell2 //Cell3 // Cell4 | | |
| Cell1 + Cell2 | Cell2 + Cell3 | Cell3 + Cell4 |
| Cell1 + Cell2 + Cell3 | Cell2 + Cell3 + | |
| Cell1 + Cell2 + Cell3 + Cell4 | Cell 4 | |
| (Cell1 + Cell2) // (Cell3 + Cell4) | | |

In the preferred embodiment, the charge controller module 140 is also connected to the first regulator 208. The first controller 502 may enable or disable the first regulator 208 and may set the output voltage of the first regulator 208 to a desired value.

In this embodiment, the charge controller module 140 is powered by the fourth regulator 226 via a conductor 230. No power is transferred when the external power supply 110 is not connected and the first SPST switch 216 within the system power supply 180 is in an open position or when the third SPST 232 within the system power supply 180 is in a closed position.

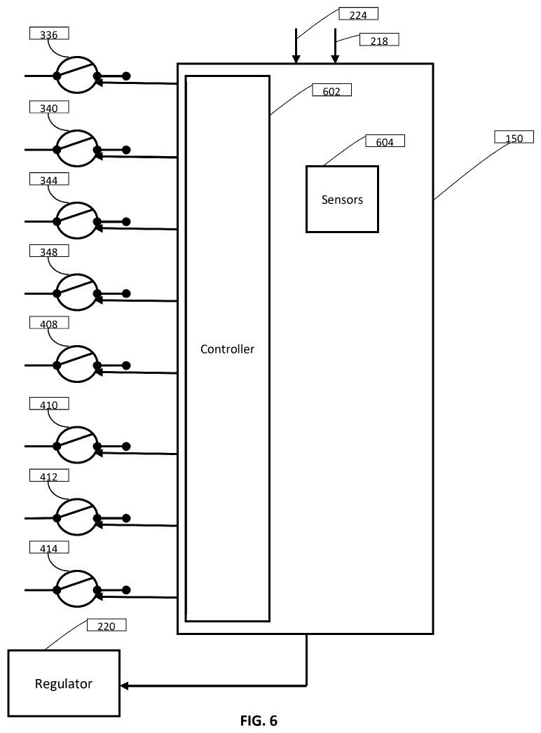

FIG. 6 shows a preferred embodiment of the discharge controller module 150. The discharge controller module 140 is responsible for configuring the switches within the switch arrangement module 120 and the system output module 130 that are paired with a diode. The controller 602 within the discharge controller module 150 does this by responding to data produced by sensors 604 within the module.

In this embodiment, the sensors 604 comprise a temperature sensor, a voltage sensor, and a bidirectional current sensor. The second controller may place any of the switches it controls in an open or closed position simultaneously or individually. The discharge controller module 150 protects the programmable battery pack 100 while discharging against low cells voltage, high charging voltage, low temperature, high temperature, high charging current and high discharge current

In the preferred embodiment, the discharge controller module 150 is also connected to and powered by the third regulator 220, which is enabled or disabled by the second controller 602. The second controller 602 is an OP-AMP, and preferably an analog comparator.

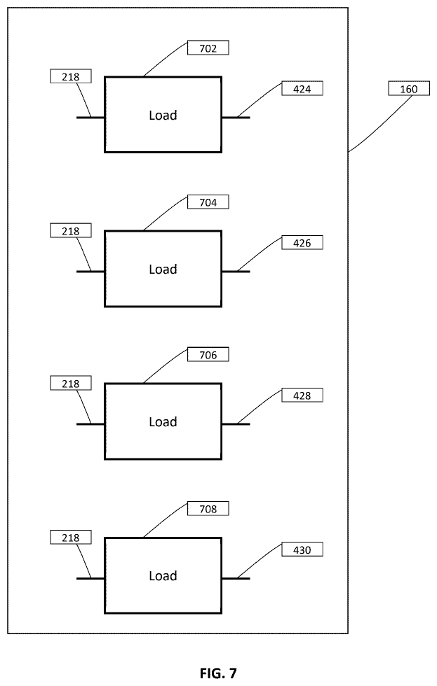

FIG. 7 shows a preferred embodiment of the external load module. The external load module has at least one load connected to both a GND and a system output.

In a preferred embodiment, the external load module 160 comprises four loads: the first load 702, the second load 704, the third load 706, and the fourth load 708. Each load is connected to its own system output. Specifically, the first load 702 is connected to the first system output 424, the second load 704 is connected to the second system output 426, the third load 706 is connected to the third system output 428, and the fourth load 708 is connected to the fourth system output 430. The system outputs provide their corresponding load with electric current if the switches within the switch arrangement module 120 and system output module 130 are properly configured.

The external loads 702, 704, 706, 708 may or may not share the same power, current, and voltage requirements. In one embodiment, the second 704 and the fourth load 708 may each accept a wide input voltage range (e.g., 6-16 volts), but require the same current. In another embodiment, the second load 704 may require a higher current than the fourth load 708. In yet another embodiment, the second load 704 and the fourth load 708 may each accept the same input voltage and require the same current.

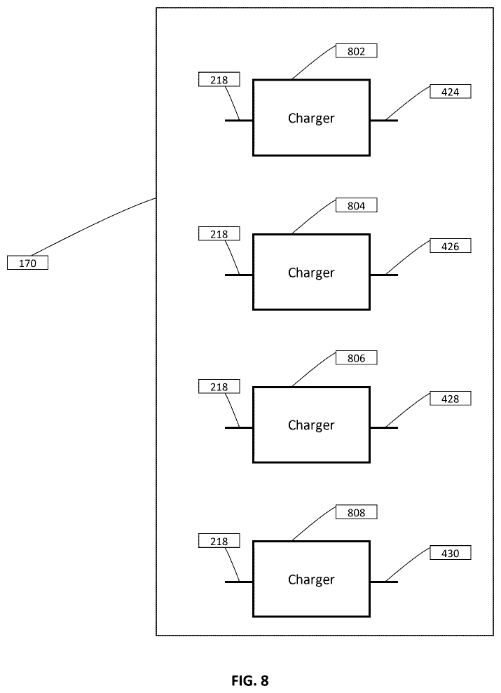

FIG. 8 shows a preferred embodiment of the external charger module. The external charger module has at least one charger connected to both a GND and a system output.

In a preferred embodiment, the external charger module 170 comprises four chargers: the first charger 802, the second charger 804, the third charger 806, and a fourth charger 808. Each charger is connected to its own system output. Specifically, the first charger 802 is connected to the first system output 424, the second charger 804 is connected to the second system output 426, the third charger 806 is connected to the third system output 428, and the fourth charger 808 is connected to the fourth system output 430. If the switches within the switch arrangement module 120 and the system output module 130 are properly configured, the system outputs are fed electric current by their corresponding chargers.

The chargers 802, 804, 806, 808 must have the compatible power, current, and voltages of their corresponding system output module 424, 426, 428, 430.

In other embodiments, the number of chargers can vary, but in all embodiments, the operator should use only one charger at a time.

Table 2 summarizes the available modes according to the status of the External Power Supply 110 and switches 216, 228, 232.
Discharge Mode OFF: System output module 130 is OFF
Charge Mode OFF: No charging or Self Balancing
System OFF: Complete shutdown

TABLE 2

| | | | | |
|---|---|---|---|---|
| External | Switch | Switch | Switch | Discharge |
| Power | 216 | 228 | 232 | Mode |
| Supply | Open | Open | Open | |
| 110 OFF | | | | |
| External | Switch | Switch | Switch | Charge |
| Power | 216 | 228 | 232 | Mode |
| Supply | Open | Open | Open | |
| 110 ON | | | | |
| External | Switch | Switch | Switch | On-Demand |
| Power | 216 | 228 | 232 | Self |
| Supply | Close | Open | Open | Balance |
| 110 OFF | | | | Mode |
| External | Switch | Switch | Switch | Charge |
| Power | 216 | 228 | 232 | Mode |
| Supply | Close | Open | Open | |
| 110 ON | | | | |
| External | Switch | Switch | Switch | Discharge |
| Power | 216 | 228 | 232 | Mode OFF |
| Supply | Open | Close | Open | |
| 110 OFF | | | | |
| External | Switch | Switch | Switch | Charge |
| Power | 216 | 228 | 232 | Mode |
| Supply | Open | Close | Open | |
| 110 ON | | | | |
| External | Switch | Switch | Switch | On-Demand |
| Power | 216 | 228 | 232 | Self |
| Supply | Close | Close | Open | Balance |
| 110 OFF | | | | Mode |
| External | Switch | Switch | Switch | Charge |
| Power | 216 | 228 | 232 | Mode |
| Supply | Close | Close | Open | |
| 110 ON | | | | |
| External | Switch | Switch | Switch | Discharge |
| Power | 216 | 228 | 232 | Mode |
| Supply | Open | Open | Close | |
| 110 OFF | | | | |
| External | Switch | Switch | Switch | Charge |
| Power | 216 | 228 | 232 | Mode OFF |
| Supply | Open | Open | Close | |
| 110 ON | | | | |
| External | Switch | Switch | Switch | System |
| Power | 216 | 228 | 232 | OFF |
| Supply | Close | Open | Close | |
| 110 OFF | | | | |
| External | Switch | Switch | Switch | Charge |
| Power | 216 | 228 | 232 | Mode OFF |
| Supply | Close | Open | Close | |
| 110 ON | | | | |
| External | Switch | Switch | Switch | System |
| Power | 216 | 228 | 232 | OFF |
| Supply | Open | Close | Close | |
| 110 OFF | | | | |
| External | Switch | Switch | Switch | Charge |
| Power | 216 | 228 | 232 | Mode OFF |
| Supply | Open | Close | Close | |
| 110 ON | | | | |
| External | Switch | Switch | Switch | System |
| Power | 216 | 228 | 232 | OFF |
| Supply | Close | Close | Close | |
| 110 OFF | | | | |
| External | Switch | Switch | Switch | Charge |
| Power | 216 | 228 | 232 | Mode OFF |
| Supply | Close | Close | Close | |
| 110 ON | | | | |

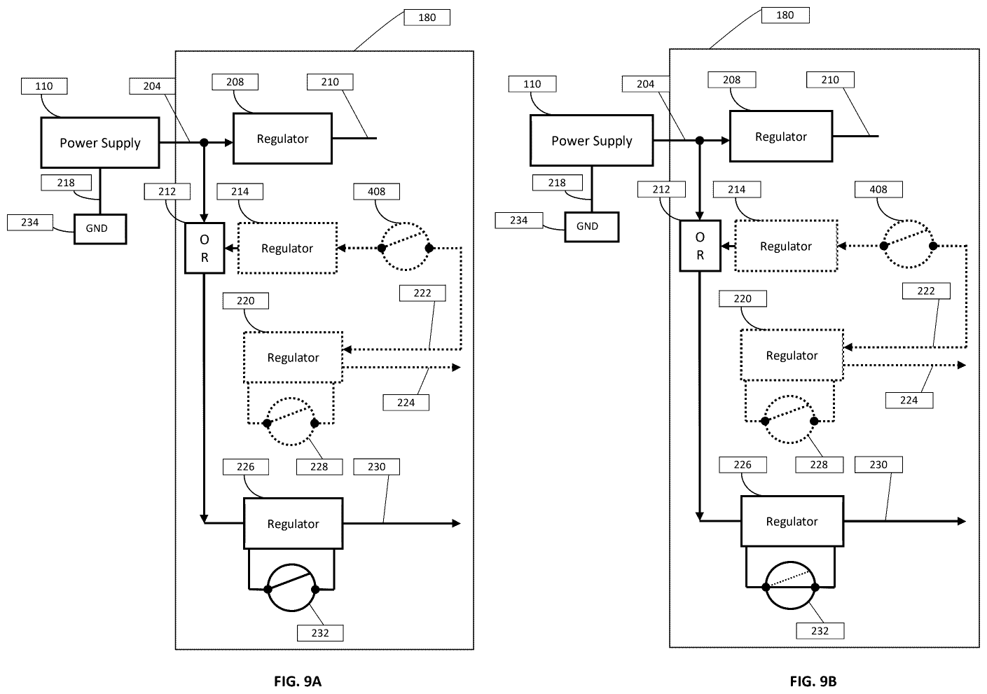

FIG. 9A shows a preferred embodiment of the system power supply 180 when the programmable battery pack 100 is in Charge Mode. The programmable battery pack 100 enters Charge Mode when the external power supply 110 is connected and powered on, when the fourth regulator 226 is active, and the at least one battery cell is connected to the internal charger module. The fourth regulator 226 is active when the third SPST switch 232 is in an open position. In Charge Mode, the charge controller module 140 is also active, while the system output module and the discharge controller module 150 are disabled. While in Charge Mode, the charge controller module 140 is able to dynamically adjust the switch configurations within the switch arrangement module 120.

FIG. 9B shows a preferred embodiment of the system power supply 180 when Charge Mode is disabled. The third SPST switch 232 is in a closed position, disabling Charge Mode.

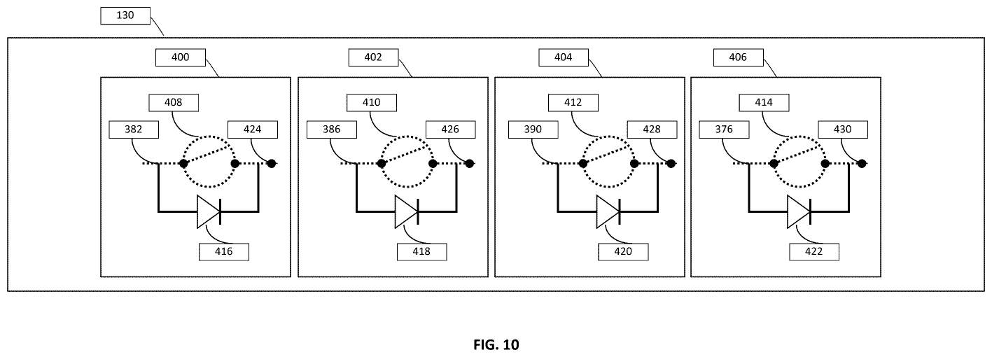

FIG. 10 shows a preferred embodiment of the system output module 130 when the programmable battery pack 100 is in Charge Mode. When in Charge Mode, the system output module 130 is disabled. When disabled, the switches 408, 410, 412, 414 within the system output module are all in open positions.

FIG. 11 shows a preferred embodiment of the discharge controller module 150 when the programmable battery pack 100 is in Charge Mode. When in Charge Mode, the discharge controller module 150 is disabled. When disabled, the switches 336, 340, 344, 348, 408, 410, 412, 414 controlled by the discharge controller module 150 are in an open position.

In this embodiment, when the discharge controller module 150 is disabled in Charge Mode, the third regulator 220 is also disabled.

In On-Demand Self Balance Mode, any voltage difference between cells connected in parallel forces electric currents to diffuse between the cells. The diffused charges decrease as the voltage difference decreases.

Similarly, when arranged in series, if one or more cells are not being charged equally, the operator may start On-Demand Self Balance Mode instead of using dedicated hardware.

While in Charge Mode or in On-Demand Self Balance Mode, the first controller 502 receives data from the sensors 504 in the charge controller module 140 and measures the voltage across each cell in the switch arrangement module 120 to locate any bad or not mounted cells and to determine the best charging arrangement.

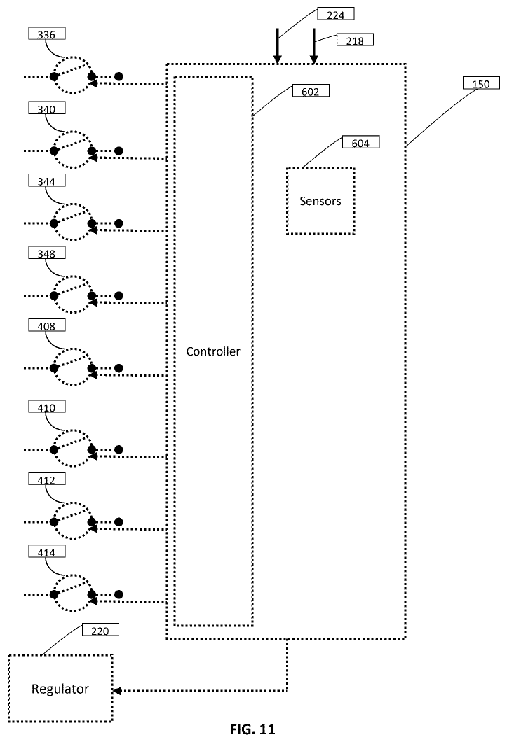

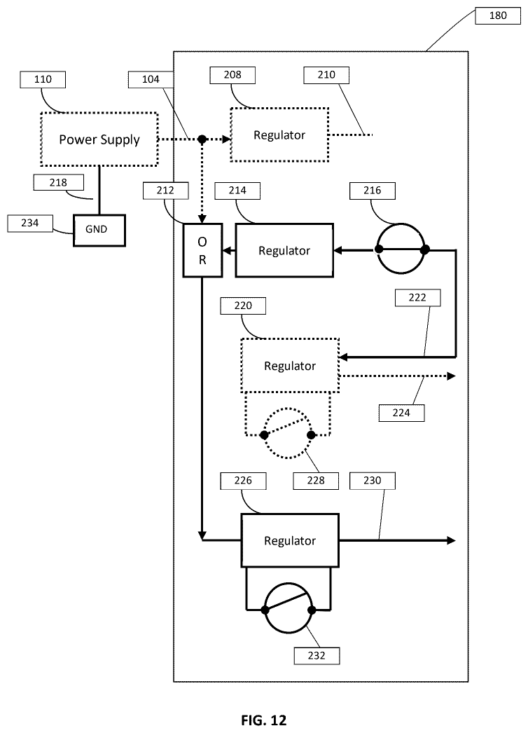

FIG. 12 shows a preferred embodiment of the system power supply 180 in On-Demand Self Balance Mode. The Programmable battery pack 100 enters On-Demand Self Balance Mode when the switch 216 is in a closed position and the external power supply 110 is off. In On-Demand Self Balance mode, the charge controller module 140 is active, while the second controller 602, the sensors 604, and the third regulator 220 within the discharge controller module 150 are disabled.

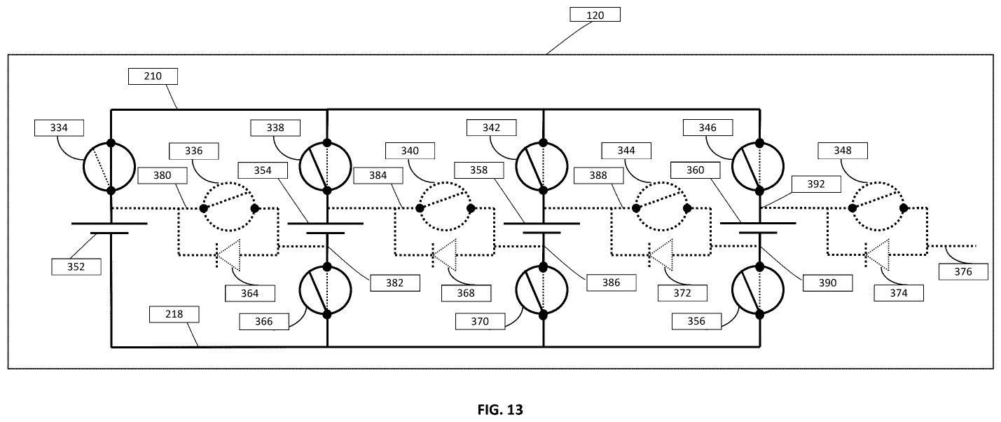

FIG. 13 shows a preferred embodiment of the switch configuration within the switch arrangement module 120 for the first controller 502 to measure the voltage across the first cell 352. The first controller 502 places the switch 334 adjacent to the first cell 352 in a closed position and each of the other six switches 338, 366, 342, 370, 346, 356 in an open position. The first controller 502 is then able to measure the voltage across the first cell 352 between the conductors 210, 218.

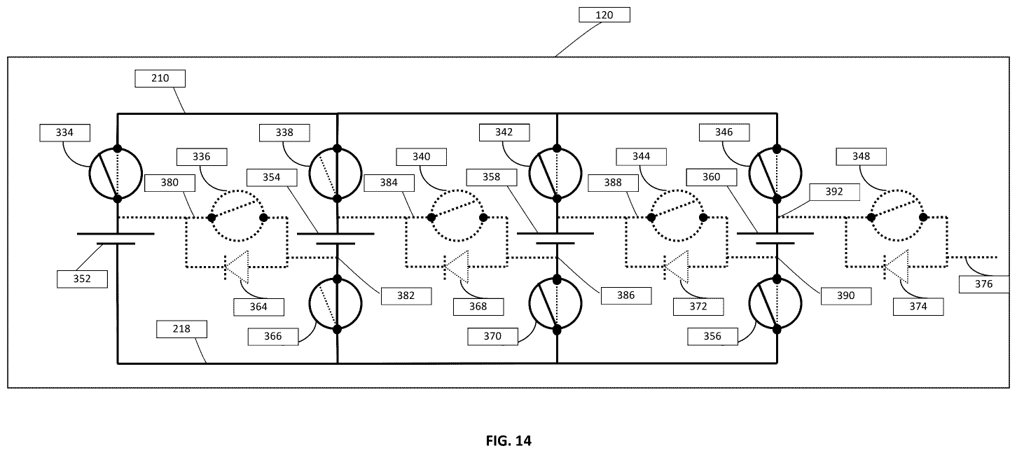

FIG. 14 shows a preferred embodiment of the switch configuration within the switch arrangement module 120 for the first controller 502 to measure the voltage across the second cell 354. The first controller 502 places the two switches 338, 366 adjacent to the second cell 354 in a closed position and each of the other five switches 334, 342, 346, 356, 370 in an open position. The first controller 502 is then able to measure the voltage across the second cell 354 between the conductors 210, 218.

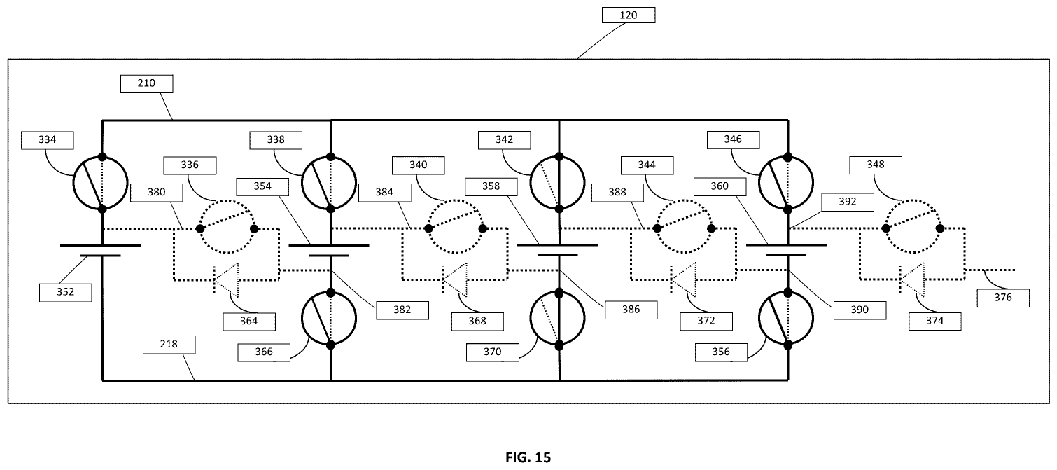

FIG. 15 shows a preferred embodiment of the switch configuration within the switch arrangement module 120 for the first controller 502 to measure the voltage across the third cell 358. The first controller 502 places the two switches 342, 370 adjacent to the third cell 358 in a closed position and each of the other five switches 334, 338, 346, 356, 366 in an open position. The first controller 502 is then able to measure the voltage across the third cell 358 between the conductors 210, 218.

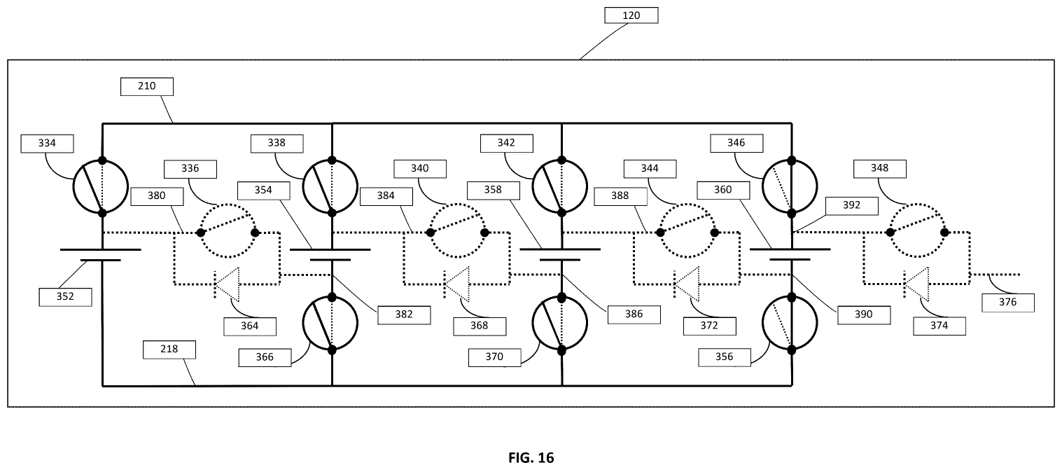

FIG. 16 shows a preferred embodiment of the switch configuration within the switch arrangement module 120 for the first controller 502 to measure the voltage across the fourth cell 360. The first controller 502 places the two switches 346, 356 adjacent to the fourth cell 360 in a closed position and each of the other five switches 334, 338, 342, 366, 370 in an open position. The first controller 502 is then able to measure the voltage across the fourth cell 360 between the conductors 210, 218.

The first controller 502 arranges the cells dynamically in response to many variables, including the power supply's 110 power, current, and voltage requirements, cell temperatures, charging current limits and charging voltages limits. The first controller 502 may decide at any time to arrange the cells in parallel or series, or a combination thereof. The first controller 502 adjusts the switches within the switch arrangement module 120 to arrange cells in series in order to charge them with the same charging current. Conversely, cells in parallel are charged equally by the same charging voltage but via different charging currents. The equal charging produced by arranging the cells in parallel eliminates the need for an additional balancing circuit or software. In conventional balancing, some stored energy in the cells may need to be dissipated passively in order to balance them. When connected in parallel during Charge Mode or On-Demand Self Balance Mode, energy dissipation is no longer needed.

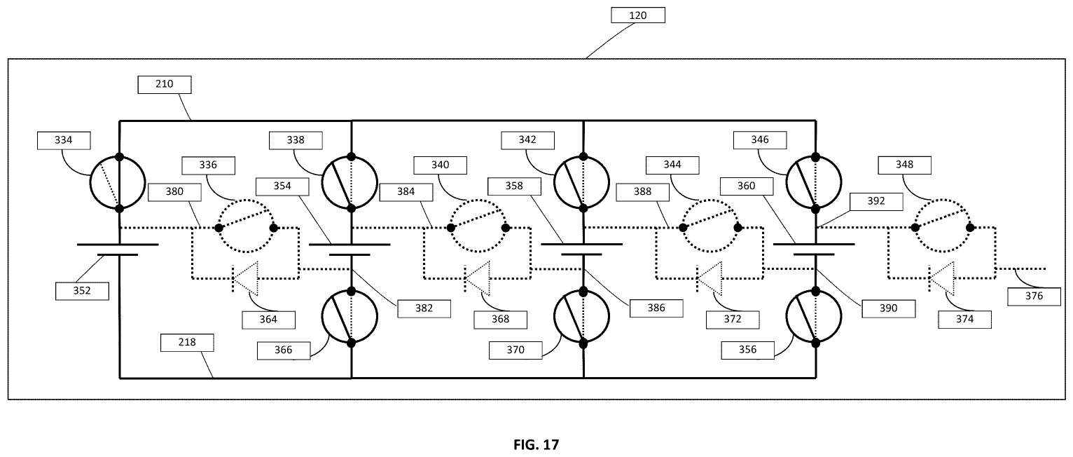

FIG. 17 shows a preferred embodiment of the switch configuration within the switch arrangement module 120 for the first controller 502 to charge the first cell 352. The first controller 502 places the switch 334 adjacent to the first cell 352 in a closed position and each of the other six switches 338, 342, 346, 356, 366, 370 in an open position. The first controller 502 then charges the first cell 352 by applying the appropriate voltage between the conductors 210, 218.

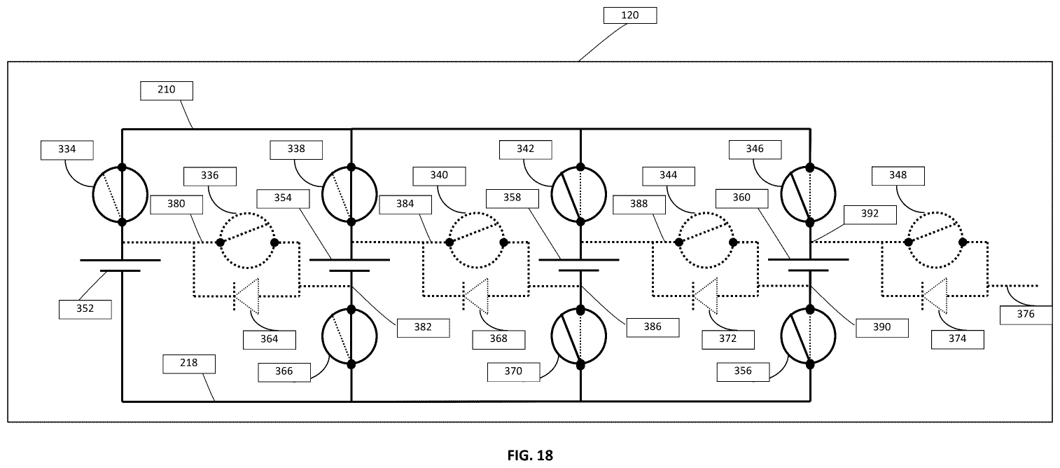

FIG. 18 shows a preferred embodiment of the switch configuration within the switch arrangement module 120 for the first controller 502 to charge the first cell 352 and the second cell 354 in parallel. The first controller 502 places the switches 334, 338, 366 adjacent to the first cell 352 and the second cell 354 in a closed position and the remaining four switches 342, 346, 356, 370 in an open position. The first controller 502 then charges the first cell 352 and the second cell 354 in parallel by applying the appropriate voltage between the conductors 210, 218.

In On-Demand Self Balance Mode, the first controller 502 may also place the first cell 352 and the second cell 354 in parallel, using the same switch configuration. In this configuration, charge diffuses across the two cells 352, 354.

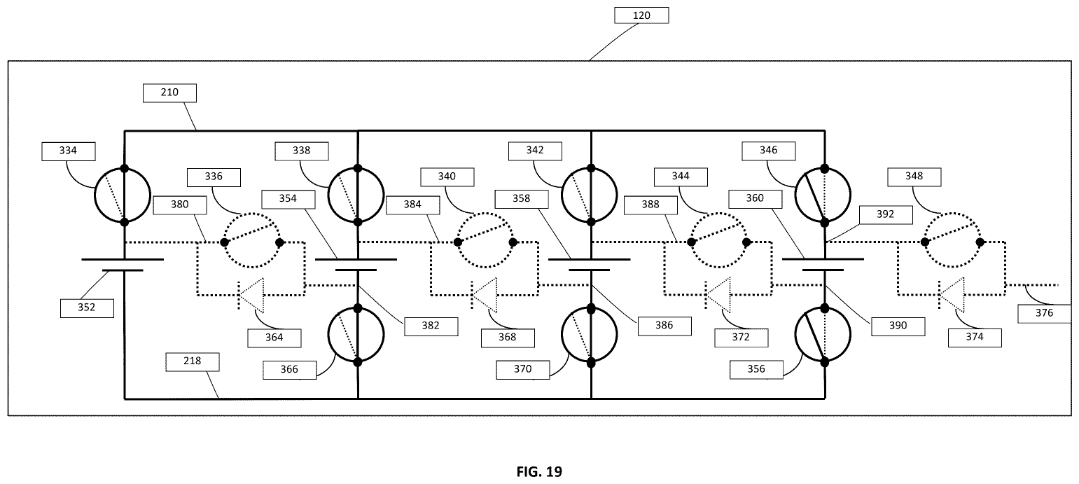

FIG. 19 shows a preferred embodiment of the switch configuration within the switch arrangement module 120 for the first controller 502 to charge the first cell 352, the second cell 354, and the third cell 358 in parallel. The first controller 502 places the switches 334, 338, 342, 366, 370 adjacent to the first cell 352, the second cell 354, and the third cell 358 in a closed position and the remaining two switches 346, 356 in an open position. The first controller 502 then charges the first cell 352, the second cell 354, and the third cell 358 in parallel by applying the appropriate voltage between the conductors 210, 218.

In On-Demand Self Balance Mode, the first controller 502 may also place the first cell 352, the second cell 354, and the third cell 358 in parallel using the same switch configuration. In this configuration, charge diffuses across the three cells 352, 354, 358.

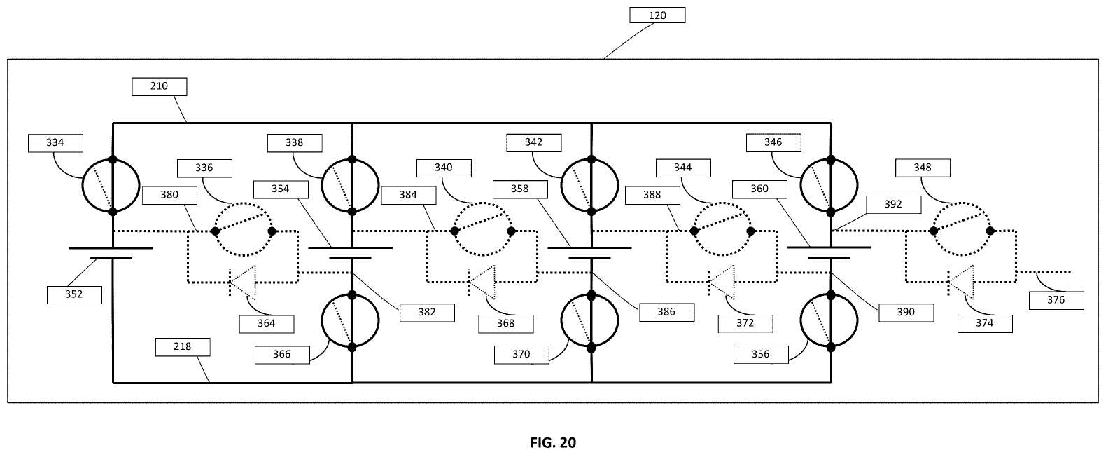

FIG. 20 shows a preferred embodiment of the switch configuration within the switch arrangement module 120 for the first controller 502 to charge all four cells 352, 354, 358, 360 in parallel. The first controller 502 places the seven switches 334, 338, 342, 346, 356, 366, 370 in a closed position. The first controller 502 then charges the four cells 352, 354, 358, 360 in parallel by applying the appropriate voltage between the conductors 210, 218.

In On-Demand Self Balance Mode, the first controller 502 may also place the four cells 352, 354, 358, 360 in parallel using the same switch configuration. In this configuration, charge diffuses across the four cells 352, 354, 358, 360.

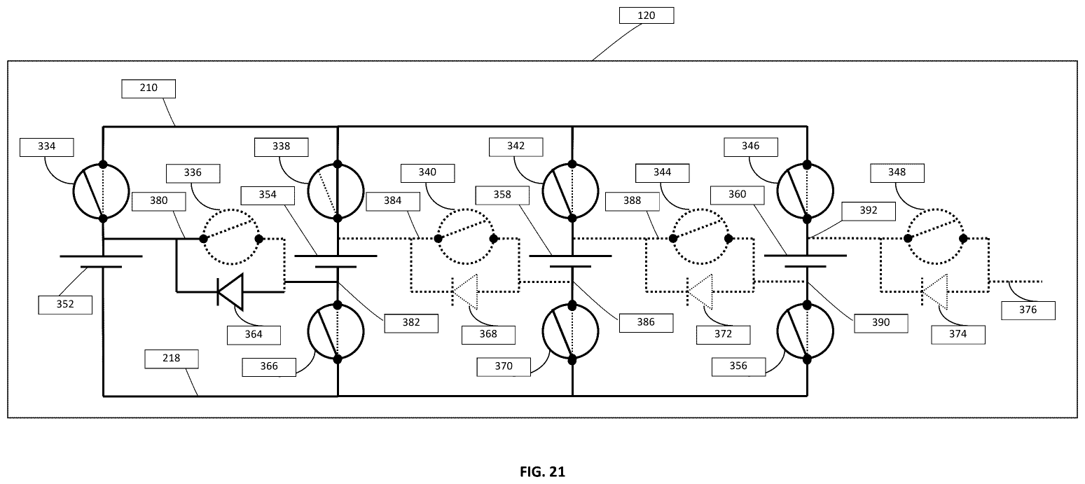

FIG. 21 shows a preferred embodiment of the switch configuration within the switch arrangement module 120 for the first controller 502 to charge the first cell 352 and the second cell 354 in series. The first controller 502 places the switch 338 adjacent to the second cell 354 in a closed position and the remaining six switches 334, 342, 346, 356, 366, 370 in an open position. The first controller 502 then charges the first cell 352 and the second cell 354 in series by applying the appropriate voltage between the conductors 210, 218.

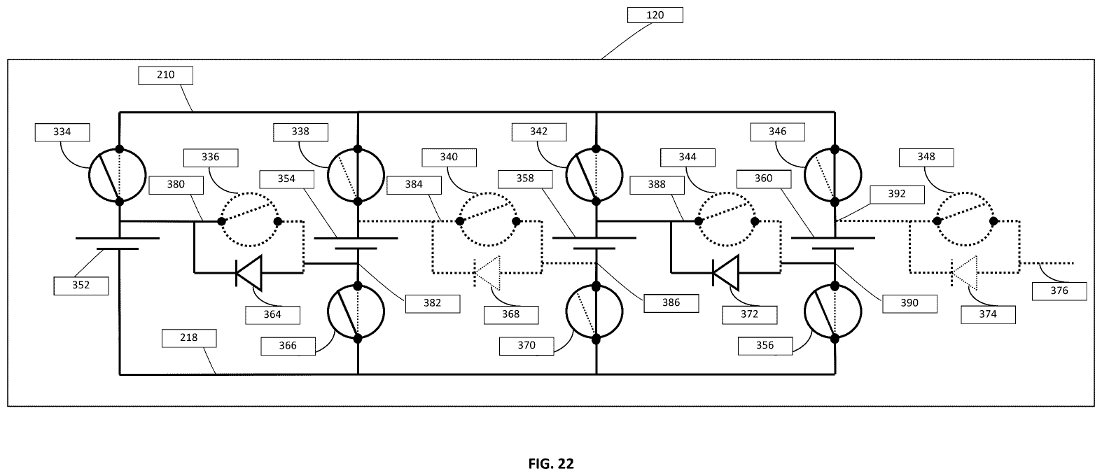

FIG. 22 shows a preferred embodiment of the switch configuration within the switch arrangement module 120 for the first controller 502 to charge the first cell 352 and the second cell 354 in parallel with the third cell 358 and the fourth cell 360. The first controller 502 places the switches 338, 346, 370 in a closed position and the remaining four switches 334, 342, 356, 366 in an open position. The first controller 502 then charges the first cell 352 and the second cell 354 in parallel with the third cell 358 and the fourth cell 360 by applying the appropriate voltage between the conductors 210, 218.

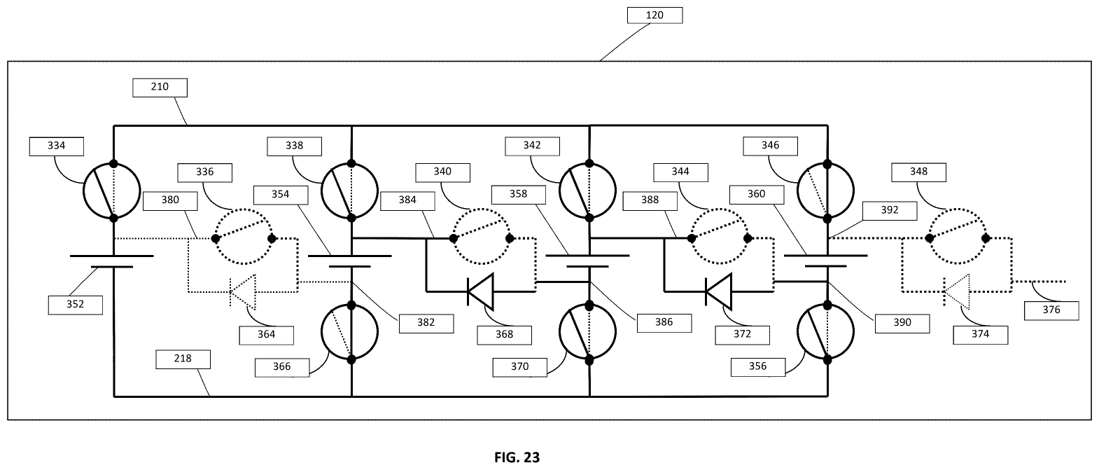

FIG. 23 shows a preferred embodiment of the switch configuration within the switch arrangement module 120 for the first controller 502 to charge the second cell 354, the third cell 358, and the fourth cell 360 in series. The first controller 502 places the switches 346, 366 in a closed position, and the remaining five switches 334, 338, 342, 356, 370 in an open position. The first controller 502 then charges the second cell 354, the third cell 338, and the fourth cell 360 in series by applying the appropriate voltage between the conductors 210, 218.

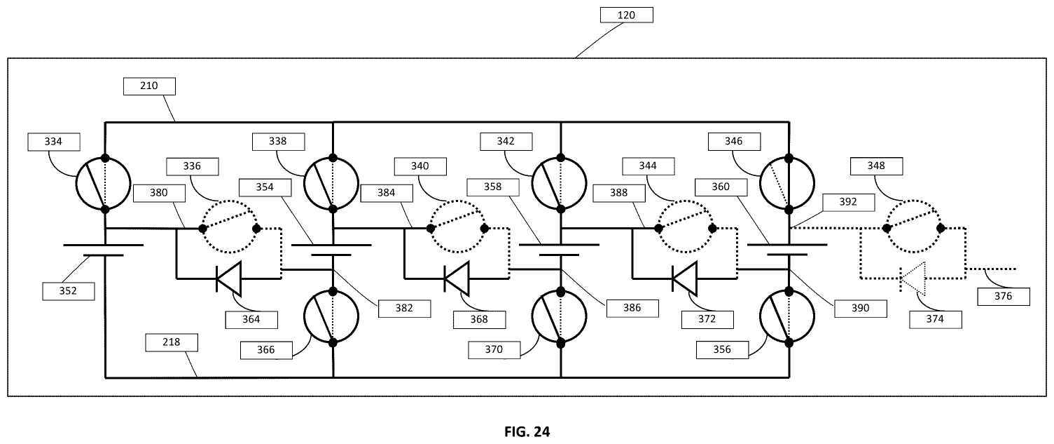

FIG. 24 shows a preferred embodiment of the switch configuration within the switch arrangement module 120 for the first controller 502 to charge the four cells 352, 354, 358, 360 in series. The first controller 502 places the switch 346 in a closed position and the remaining switches 334, 338, 342, 356, 366, 370 in an open position. The first controller 502 then charges the four cells 352, 354, 358, 360 in series by applying the appropriate voltage between the conductors 210, 218.

The programmable battery pack 100 enters Discharge Mode when the switches 216, 228 are in an open position, and the power supply 110 is off. In Discharge Mode, the system output module 130 is enabled and power is being supplied to or charged by at least one external load or at least one external charger.

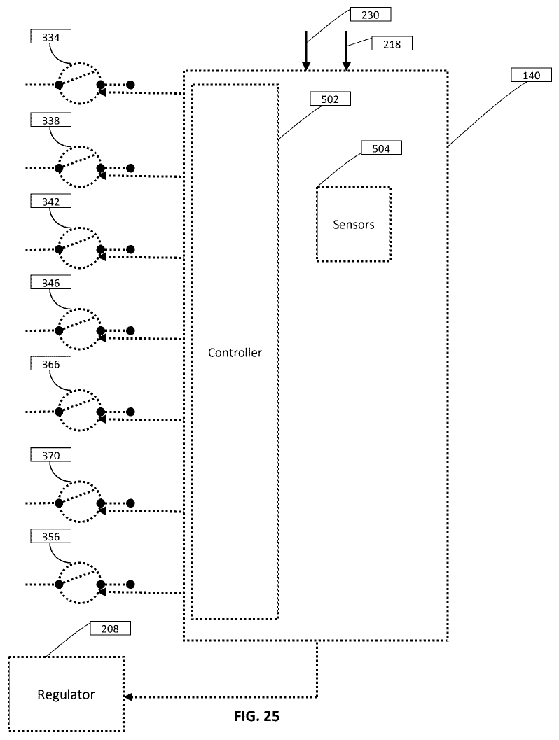

FIG. 25 shows a preferred embodiment of the charge controller module 140 in Discharge Mode. This occurs when the voltage at the conductor 230 is zero volts. The conductor 230 connects the controller module 140 to the fourth regulator 226. In Discharge Mode, the fourth regulator 226 is inactive, therefore creating the absence of voltage at the conductor 230.

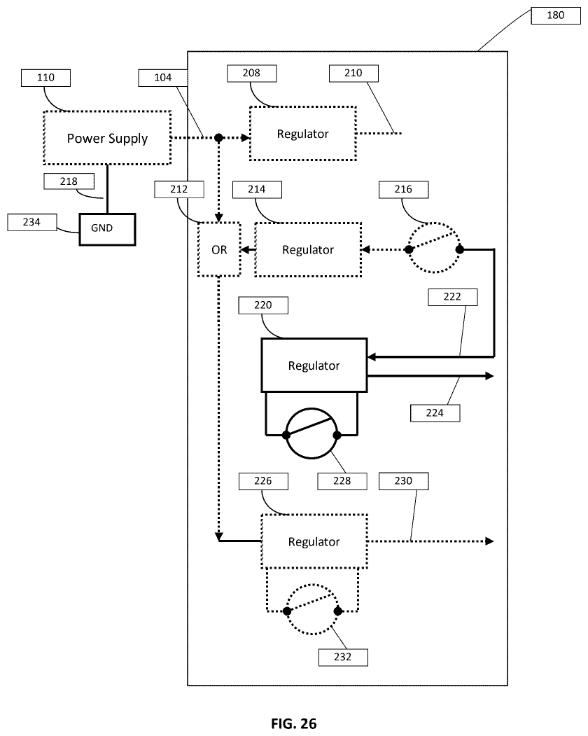

FIG. 26 shows a preferred embodiment of the system power supply 180 in Discharge Mode. In Discharge Mode, the third regulator 220 is active, which regulates the voltage of the first cell 352, in turn activating the discharge controller 150.

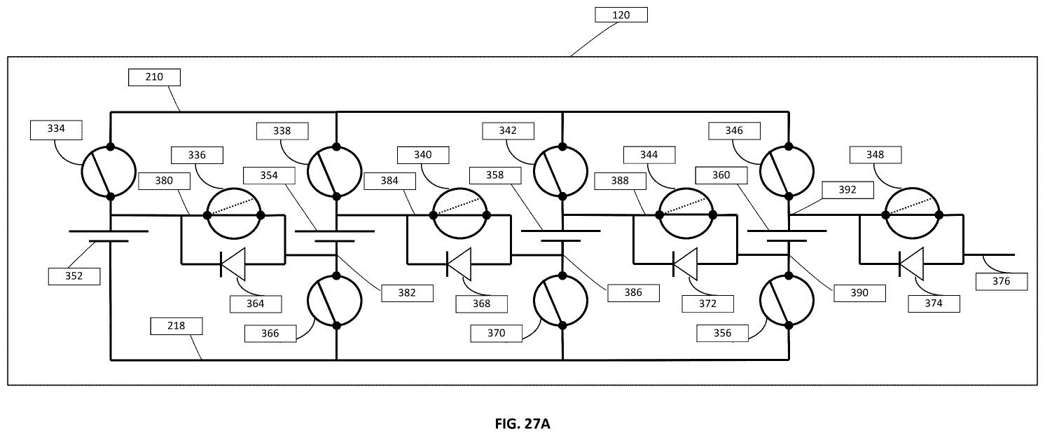

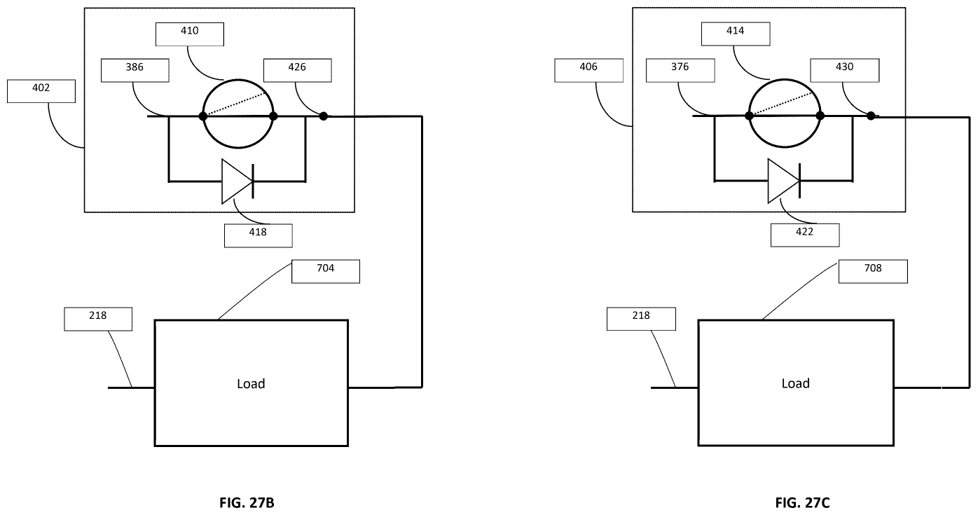

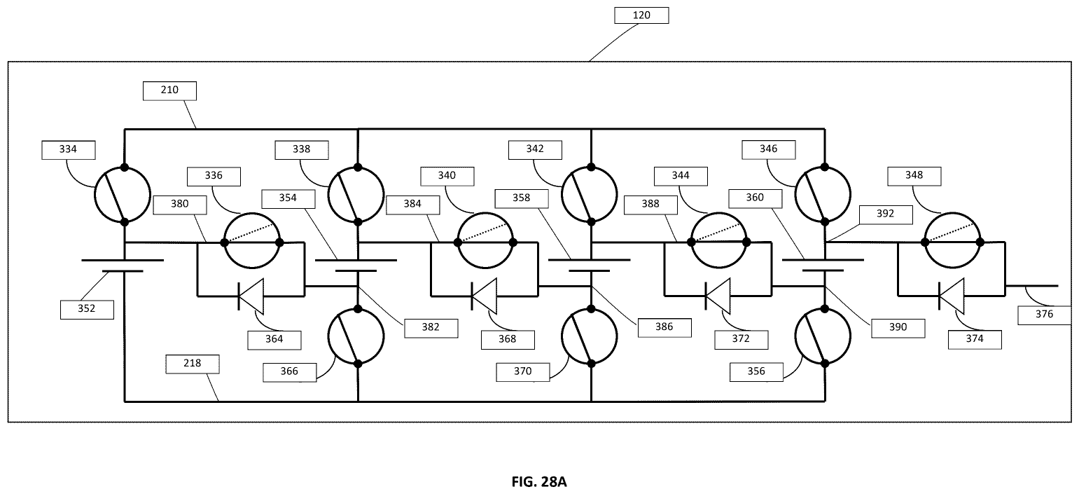

FIG. 27A-27C show a preferred embodiment of the switch arrangement module 120, second system output 426 and fourth system output 430 in Discharge Mode. As shown in FIGS. 27B and 27C, the second system output 426 and the fourth system output 430 are each simultaneously connected to an external load 704, 708. In this embodiment, the power, current, and voltage requirements of the external loads 704, 708 do not have to be the same. In other embodiments, the power, current and voltage requirements of the loads may differ.

In this embodiment, the output voltage at the second system output 426 is equal to the sum of voltages of the first cell 352 and the second cell 354 (e.g., 3.3+3.3=6.6 volts). Further, the output voltage at the fourth system output 430 is equal to the sum of voltages of all four cells 352, 354, 358, 360 (e.g., 3.3+3.3+3.3+3.3=13.2 volts).

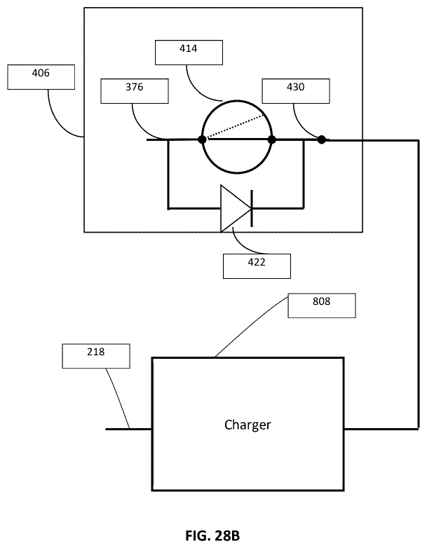

FIG. 28A-28B shows a preferred embodiment of the switch arrangement module 120 and the fourth system output 430 in Discharge Mode. As shown in FIG. 28B, the fourth system output 430 is connected to an external charger 808. In this embodiment, the power, current, and voltage requirements of the external charger 808 must match those of the fourth system output 430. For example, in FIG. 28B, if the voltage at the fourth system output 430 is 13.2 volts, then the voltage of the external charger 808 should not be much higher than 14.4 volts (assuming that the cell voltage is 3.3 volts and charging voltage is 3.6 volts). In other embodiments, a different system output may be used.

What is claimed is:

1. A programmable battery pack, comprising:
a system power supply having at least one linear regulator and at least one single pole single throw (SPST) switch, wherein the system power supply is connected to:
a switch arrangement module having at least one rechargeable battery cell with a positive terminal and a negative terminal and at least one single pole single throw (SPST) switch; and
an at least one controller module having a micro-controller executing a pre-programmed firmware; and
an external power supply having a positive terminal and a negative terminal, wherein:
in a Charge Mode, the positive terminal of the external power supply is connected to the system power supply, the negative terminal of the external power supply is connected to a common ground, and the external power supply is on;
in an On-Demand Self-Balance Mode, the negative terminal of the external power supply is connected to a common ground, the positive terminal of the external power supply is not connected to the system power supply, or the external power supply is off;
and in a Discharge Mode, the negative terminal of the external power supply is connected to a common ground, the positive terminal of the external power supply is not connected to the system power supply, or the external power supply is off.

2. The controller module of claim 1, further comprising:
at least one single pole single throw (SPST) switch; and
at least one sensor module having a temperature sensor, a voltage sensor, and a current sensor, wherein:
data obtained from the sensor module is compared to the pre-programmed firmware of the micro-controller to direct changes to the switch arrangement module.

3. The controller module of claim 1, wherein:
the at least one regulator comprises a first regulator, a second regulator, a third regulator, and a fourth regulator;
the output of the fourth regulator is connected to the controller module;
the output of the controller module is connected to the first regulator; and
the output of the first regulator is connected to the switch arrangement module.

4. The controller module of claim 1, wherein:
in Charge Mode, the micro-controller increases the output voltage of the first regulator to the maximum charge voltage, wherein:
the maximum charge voltage is equal to the maximum charge voltage of an at least one cell in the switch arrangement module multiplied times the number of cells when the at least one cell is arranged in series; and
the maximum charge voltage is equal to the maximum charge voltage of the at least one cell when the at least one cell is alone or arranged in parallel.

5. The programmable battery pack of claim 1, further comprising:
a charger module;
a load module; and
an output module, wherein:
the output module connects the charger module to the switch arrangement module; and
the output module connects the load module to the switch arrangement module.

6. The output module of claim 2, further comprising:
at least one system output; and
at least one single pole single throw (SPST) switch.

7. The charger module of claim 2, further comprising:
at least one charger.

8. The load module of claim 2, further comprising:
at least one load.

9. A method for managing battery charging of an at least one battery cell in a Charge Mode utilizing the programmable battery pack of claim 1, comprising the steps of:
using a switch in an output module to de-couple an external module from an at least one battery cell within a switch arrangement module;
using a first switch configuration to couple at least one battery cell within the switch arrangement module with an internal charger module;
determining, using a charge controller module, a first battery characteristic of the at least one battery cell, wherein:
the first battery characteristic comprises a voltage across a positive terminal and negative terminal of the at least one battery cell;
determining, using a charge controller module, a second battery characteristic of the at least one battery cell, wherein:
the second battery characteristic comprises a temperature of the at least one battery cell;
determining, using a charge controller module, a third battery characteristic of the at least one battery cell, wherein:
the third battery characteristic comprises a charging current of the at least one battery cell;
configuring the at least one switch in an alternate switch configuration within a switch arrangement module.

10. The method of claim 9, further comprising comparing the first battery characteristic, the second battery characteristic, and third battery characteristic to a pre-programmed firmware to determine the alternate switch configuration.

11. A method for managing battery discharging of an at least one battery cell in a Discharge Mode, utilizing the programmable battery pack of claim 1, comprising the steps of:
using a switch in an output module to couple an external module to an at least one battery cell within a switch arrangement module;
determining, using a discharge controller module, a first battery characteristic of the at least one battery cell, wherein:
the first battery characteristic comprises a voltage across a positive terminal and negative terminal of the at least one battery cell;
determining, using a discharge controller module, a second battery characteristic of the at least one battery cell, wherein:
the second battery characteristic comprises a temperature of the at least one battery cell;
determining, using a discharge controller module, a third battery characteristic of the at least one battery cell, wherein:
the third battery characteristic comprises a bidirectional charging current of the at least one battery cell;
configuring the at least one switch in an alternate switch configuration within a switch arrangement module.

12. The method of claim 11, further comprising comparing the first battery characteristic, the second battery characteristic, and third battery characteristic to determine the alternate switch configuration.

13. A method for managing battery balancing of an at least one battery cell in On-Demand Self-Balance Mode, utilizing the programmable battery pack of claim 1, comprising the steps of:
using a switch in an output module to de-couple an external module from an at least one battery cell within a switch arrangement module;
determining, using a charge controller module, a first battery characteristic, wherein:
the first battery characteristic comprises a voltage difference across a positive terminal and negative terminal of the at least one battery cell;
configuring the at least one battery cell in parallel, allowing current to diffuse across the at least one battery cell.
